(19) United States
(12) Patent Application Publication
(10) Pub. No.: US 2011/0066464 A1
(43) Pub. Date: Mar. 17, 2011

(54) METHOD AND SYSTEM OF AUTOMATED CORRELATION OF DATA ACROSS DISTINCT SURVEYS

(76) Inventor: VARUGHESE GEORGE, Union City, CA (US)

(21) Appl. No.: 12/882,445

(22) Filed: Sep. 15, 2010

Related U.S. Application Data
(60) Provisional application No. 61/242,508, filed on Sep. 15, 2009.

(51) Int. Cl. G06Q 10/00; G06Q 30/00

(52) U.S. Cl. 705/7.32

(57) ABSTRACT

Disclosed are a method, an apparatus, and/or a system of automated correlation of data across distinct surveys. In one embodiment, a method includes conducting a survey on a set of participants. The method also includes obtaining a set of data from a set of participants through a network coupled to a data processing system. In addition, the method includes compiling the set of data in an enterprise resource based on the set of data obtained from the set of participants. The method further includes analyzing the set of data in the enterprise resource. The method also includes creating a marketing plan.

### CLAIM OF PRIORITY

This is a utility application and claims priority from U.S. Provisional application No. 61/242,508 titled “METHOD AND SYSTEM OF AUTOMATED CORRELATION OF DATA ACROSS DISTINCT SURVEYS” filed on Sep. 15, 2009.

### FIELD OF TECHNOLOGY

This disclosure relates generally to data aggregation and enterprise management and in one embodiment to a method, system and an apparatus of automated correlation of data across distinct surveys.

### BACKGROUND

A survey may be conducted for gathering a set of data from consumers for a specific product or a service. Each survey may be distinct and specific to a particular product or a service. There may be different types of surveys, for example, interviews and questionnaire. Questionnaires may be a type of survey. A questionnaire may be a research instrument including of a series of questions and/or other prompts for the purpose of gathering information from respondents. Questionnaires may provide advantages over some other types of surveys as the questionnaires are cost effective, do not require as much effort from the questioner as verbal or telephone surveys, and may often have standardized answers that make it simple to compile data. However, such standardized answers may frustrate consumers. Questionnaires may also be limited by the fact that respondents (e.g., consumers) must be able to read the questions and respond to them.

As a type of survey, the questionnaires also have many of the same problems relating to question construction and wording that exist in other types of opinion polls. Usually, a questionnaire may include a number of questions that the respondent has to answer in a particular format that makes the questionnaire.

Response obtained from the consumers for the survey may be analyzed to obtain understanding of consumers' interest on a product or a service. Also, each consumer may have different interest and responses towards the product or a service. Since, the survey is limited to a particular product or a service, the analyzed information can be applied only to create am operation plan for that particular product or service.

### SUMMARY

Disclosed are a method, an apparatus, and/or a system of automated correlation of data across distinct surveys.

In one aspect, a method includes conducting a survey on a set of participants. The method also includes obtaining a set of data from a set of participants through a network coupled to a data processing system. In addition, the method includes compiling the set of data in an enterprise resource based on the set of data obtained from the set of participants. The method further includes analyzing the set of data in the enterprise resource. The method also includes creating a marketing plan.

The method may include defining a problem and researching a design specification to solve the problem. The method may also include conducting the survey based on the design specification and collecting the set of data obtained from the survey. The method may further include refining the set of data to produce a result and writing and presenting a research report based on the result.

In addition, the method may include identifying a set of information associated with the problem. The method may also include conceptualizing the set of information associated with the problem and defining a set of concepts associated with the problem. The method may further include translating the set of concepts into a set of observable and measurably behaviors. The method may also include creating the survey based on the set of concepts associated with the problem.

Furthermore, the method may include researching the design specification to create a methodology for the survey. The methodology may be one or more of a questionnaire, a poll, and a scale. The method may also include generating a set of questions based on the methodology and determining an order of the questions based on the methodology. The method may further include scaling the design specification to include a definition of preferences that are to be rated. The method may also include sampling the design specification to determine a set of properties associated with the design specification.

The set of properties associated with the design specification may be one or more of a total population size, a sample size necessary for the total population size and a sampling method. The sampling method may be one or more of a probability sampling, a cluster sampling, a stratified sampling, a simple random sampling, a multistage sampling, a systematic sampling, a non-probability sampling, a convenience sampling, a judgment sampling, a purposive sampling, a quota sampling and a snowball sampling. The set of data may be collected through one or more of a mail collection, a telephone collection, an internet collection, a public place collection, an oral survey collection, a door-to-door collection and a mall intercepts collection.

The method may include performing a set of adjustments to the set of data such that the data is compatible with a group of statistical techniques. The set of adjustments may be one or more of a codification of the data, a re-specification of the data, an assigning of numbers to the data, a performing of consistency checks on the data, a substituting of the data, a deleting of the data, a weighing of the data, an assigning of dummy variables to the data, a transformations of a scale of the data and a standardizing of the scale of the data. The method may also include producing the result based on the set of adjustments and performing a set of statistical analysis on the result. The set of statistical analysis may be one or more of a performing a descriptive statistical analysis, an inferential statistical analysis, a making of an inference from the sample to the whole population and a testing of the result for statistical significance.

The method may further include analyzing the result. The result may be analyzed through one or more of an interpretation of the result, a drawing of a conclusion and a relating of the result to a similar research. The method may also include preparing the research report based on the result. The research input may include one or more of an executive summary, an objective, a methodology, a main finding, a detailed chart and a diagram.

In addition, the method may include responding to the survey through a client device. The method may also include communicating a response of the participant over the network and aggregating the response and a set of responses in an aggregate survey. The method may further include providing an Enterprise Feedback Management (EFM) system to centrally manage a deployment of the survey. The EFM system may be one or more of a system of processes and a software. The method may also include dispersing an authoring and an analysis of the survey throughout an organization through the EFM system.

Furthermore, the method may include providing a set of different roles to a set of users in the organization based on a permission level of the user through the EFM system. The set of different roles may be one or more of a novice survey author, a professional survey author, a survey reporter and a translator. The method may also include providing a set of options associated with survey design through the EFM system. The set of options associated with survey design may pertain to features such as one or more of a question, a page rotation, a quota management, an advanced skip pattern and a branching. The method may also include providing an advanced reporting feature through the EFM system. The advanced reporting feature may offer one or more of an advanced statistical analysis feature and a centralized panel management feature.

The method may further include providing a workflow process enabling the set of users of the organization to work on a set of multiple surveys efficiently. The method may also include permitting a second user of the organization to approve a survey authored by a first user of the organization. In addition, the method may also include generating a set of attributes based on the set of data through a processor and storing the set of attributes in a database.

The method may include analyzing the set of data through an Enterprise Resource Platform (ERP). The set of data may be one or more of a biographical data, a historical data, a geographical data, a general data, a specific data, a collective data, an opinion data, an attitudinal data and a behavioral data. In addition, the method may include identifying the participant of the survey and tracking a response of the participant. The method may also include creating a unique registration record for the participant and generating a compressive data associated with a unique data of the participant.

The method may further include analyzing the compressive data associated with the unique data of the participant to look for trends. The method may also include focusing on a portion of the compressive data associated with the unique data of the participant based on a preference of the user. The method further may also include comparing the participant of the survey with a set of all participants in the database and decoupling a context and an attribution process associated with the set of data.

In addition, the method may include capturing a hierarchy and a relationship between the set of data captured through a set of multiple surveys. The method may also include combining the set of data captured through the set of multiple surveys. The method may further include analyzing and reporting based on the set of data captured through the set of multiple surveys. The method may also include permitting the participant to update and maintain the set of data in the enterprise resource.

In another aspect, a method includes creating a survey to solve a problem and sending a survey to a participant through a network. The method also includes collecting a set of data associated with the survey based on a response of the participant. The method further includes compiling the set of data in an enterprise resource and generating a set of attributes based on the set of data through a processor. The method also includes decoupling a context and an attribution process associated with the set of data to filter and categorize the set of data and analyzing the set of data.

In yet another embodiment, a system includes an enterprise resource to store a set of data collected from a set of participants. The system also includes a survey to find a solution to a problem. The system further includes a network to communicate the survey from the set of participants to the enterprise resource. The system also includes an attribution process to generate a set of attributes of the set of data. In addition, the system includes a processor to generate the set of attributes and to decouple a context of the data and a set of attributes of the set of data. The system also includes a data processing system to collect, analyze and organize the set of data obtained. The data processing system further includes one or more of a processor, a main memory, a static memory, a bus, a video display, an alpha-numeric input device, a cursor control device, a drive unit, a signal generation device, a network interface device, a machine readable medium, and a set of instructions.

### BRIEF DESCRIPTION OF THE DRAWINGS

The embodiments of this invention are illustrated by way of example and not limitation in the figures of the accompanying drawings, in which like references indicate similar elements and in which:

FIG. 1 illustrates a system performing a qualitative marketing research, according to one or more embodiments.

FIG. 2 illustrates a system of quantitative marketing research where user responds to surveys providing information, according to one or more embodiments.

FIG. 3 illustrates a process of attribution from the surveys, according to one or more embodiments.

FIG. 4 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

Disclosed are a method, an apparatus, and/or a system of automated correlation of data across distinct surveys. Although the present embodiments have been described with reference to specific example embodiments, it will be evident that various modifications and changes may be made to these embodiments without departing from the broader spirit and scope of the various embodiments.

Quantitative marketing research may be an application of quantitative research techniques to fields of marketing. Roots of the quantitative marketing research may be found from the positivist view of the world, and from a modern marketing viewpoint that marketing is an interactive process in which both a buyer and seller reach a satisfying agreement on the “four Ps” of marketing: Product, Price, Place (location) and Promotion.

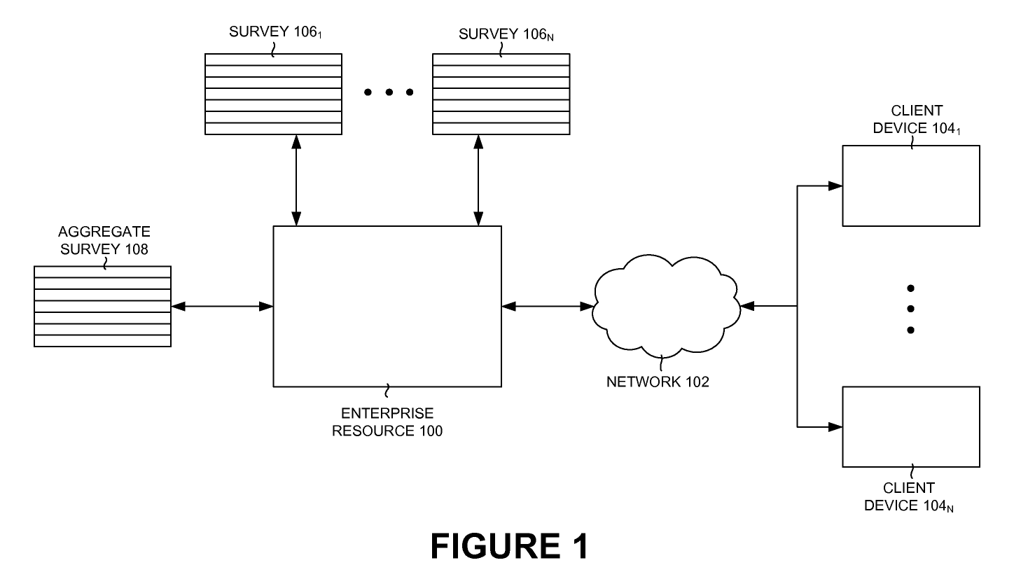

FIG. 1 illustrates a system performing a qualitative marketing research, according to one or more embodiments. As a social research method, the quantitative marketing research may involve construction of questionnaires and scales in one or more surveys. In one or more embodiments, a survey may be conducted on a set of participants. Individuals responding (e.g., respondents) may be asked to complete a survey(s) 106_{1-N}. In one or more embodiments, the surveys 106_{1-N} may be conducted online. In some embodiments, survey may include, but not limited to opinion polls and questionnaire.

Marketers may use information obtained from the respondents to understand needs of individuals in a marketplace, to create strategies and/or marketing plans. In one or more embodiments, the marketers may create an enterprise resource 100 based on the information obtained from the respondents to create strategies and/or marketing plans. Also, the response obtained may be compiled in the enterprise resource based on the set of data obtained from the set of participants.

In one or more embodiments, there may be five major and important steps involved in the research process as described herein. The five steps include

### 1. Defining the Problem.

### 2. Research Design.

### 3. Data Collection.

### 4. Analysis.

### 5. Report Writing and Presentation.

The brief discussion on each of these steps describe above are:

### 1. Defining the Problem:

a) Problem audit and problem definition that includes identifying the problem, identifying various aspects of the problem and identifying information associated with the problem.
b) Conceptualization and operationalization that includes definition of concepts involved, process of translation of these defined concepts into observable and measurable behaviors.
c) Hypothesis specification that includes claim(s) to be tested. The survey may be created based on the set of concepts associated with the problem.

### 2. Research Design:

a) Research design specification that includes identification of methodology to be used, for example, questionnaire and survey.
b) Question specification that includes identification of questions to be asked and order of questions to be asked.
c) Scale specification that includes definition of preferences to be rated.
d) Sampling design specification that includes finding out total population, sample size necessary for the population, sampling method to be uses, etc.

In one or more embodiments, the sampling method may include probability sampling (e.g., cluster sampling, stratified sampling, simple random sampling, multistage sampling, and systematic sampling) and non-probability sampling (e.g., Convenience Sampling, judgment Sampling, Purposive Sampling, Quota Sampling, Snowball Sampling, etc.).

### 3. Data Collection:

a) Data collection through use of mails, telephone, internet, mall intercepts, a public place collection, an oral survey collection, a door-to-door collection, etc.
b) Codification and re-specification that includes making adjustments to raw data so it may be made compatible with statistical techniques and with objectives of the research. For example, the codification and re-specification includes assigning numbers, performing consistency checks, substitutions, deletions, weighting, dummy variables, scale transformations, scale standardization, etc.

### 4. Analysis:

a) Statistical analysis that includes performing various descriptive and inferential techniques on the raw data (e.g., information obtained from surveys), making inferences from the sample to the whole population and testing the results for statistical significance.
b) Interpret and integrate findings including interpretation of the results, drawing conclusions, and relating findings to similar research.

The statistical analysis may include one or more of a performing a descriptive statistical analysis, an inferential statistical analysis, a making of an inference from the sample to the whole population and a testing of the result for statistical significance.

### 5. Report Writing and Presentation:

a) The report may include headings such as: 1) executive summary; 2) objectives; 3) methodology; 4) main findings; 5) detailed charts and diagrams. The report may be presented to the client in a 10 minute presentation with provisions for questionnaire.

In one or more embodiments, the design step may involve a pilot study to in order to discover any hidden issues. The codification and analysis steps may be performed using data processing system (e.g., computer, servers) using software such as DAP (statistics and graphics program) or PSPP (a computer program used for statistical analysis). The data collection steps, in some instances may be made automated, but may require significant manpower to undertake. Interpretation of the data may provide valuable insights.

Questionnaires may be a type of survey. A questionnaire may be a research instrument including of a series of questions and/or other prompts for the purpose of gathering information from respondents. Although the questionnaires are often designed for statistical analysis of the responses, it may not be not always the case.

Questionnaires may provide advantages over some other types of surveys as the questionnaires are cost effective, do not require as much effort from the questioner as verbal or telephone surveys, and may often have standardized answers that make it simple to compile data. However, such standardized answers may frustrate users. Questionnaires may also be limited by the fact that respondents must be able to read the questions and respond to them. Thus, for some demographic groups conducting a survey through questionnaire may not be practical.

As a type of survey, the questionnaires also have many of the same problems relating to question construction and wording that exist in other types of opinion polls. Usually, a questionnaire may include a number of questions that the respondent has to answer in a particular format. In one embodiment, there may be two kinds of questions. The questions include open-ended questions and closed-ended questions. The open-ended question may require the respondent to formulate an answer, whereas the closed-ended question may have the respondent choose an answer from a given number of options. The response options for a closed-ended question may have to be exhaustive and mutually exclusive. In one or more embodiments, four kinds of response scales for closed-ended questions may be identified as described below.

1. Dichotomous, where the respondent has two options.

2. Nominal-polytomous, where the respondent has more than two unordered options.

3. Ordinal-polytomous, where the respondent has more than two ordered options.

4. (bounded) Continuous, where the respondent is presented with a continuous scale.

In one or more embodiments, the respondent may respond through a client device(s) 104_{1-N}. The client device may include, but are not limited to a computer, a laptop, a mobile phone device. The response (e.g., a set of data) may be communicated to the enterprise resource 100 over a network 102. The set of data may be obtained from a set of participants through the network 102 coupled to a data processing system such as a client device 104.

Further, the respondent's answer to open-ended questions may be coded into a response scale. In one or more embodiments, the surveys 106_{1-N} and the responses from the respondents may be aggregated 108.

In one or more embodiments, the questionnaires may be designed to gather information that can range from factual and behavioral to an attitudinal and from general to more specific. In one or more embodiments, the questionnaire may be a series of questions asked to individuals to obtain statistically useful information about a given topic. In one or more embodiments, the questionnaires are constructed and administered, as an instrument by which statements can be made about specific groups or people or entire populations.

The questionnaires may be frequently used in quantitative marketing research and social research. The questionnaires technique may be a valuable method of collecting a wide range of information from a large number of individuals, often referred to as respondents.

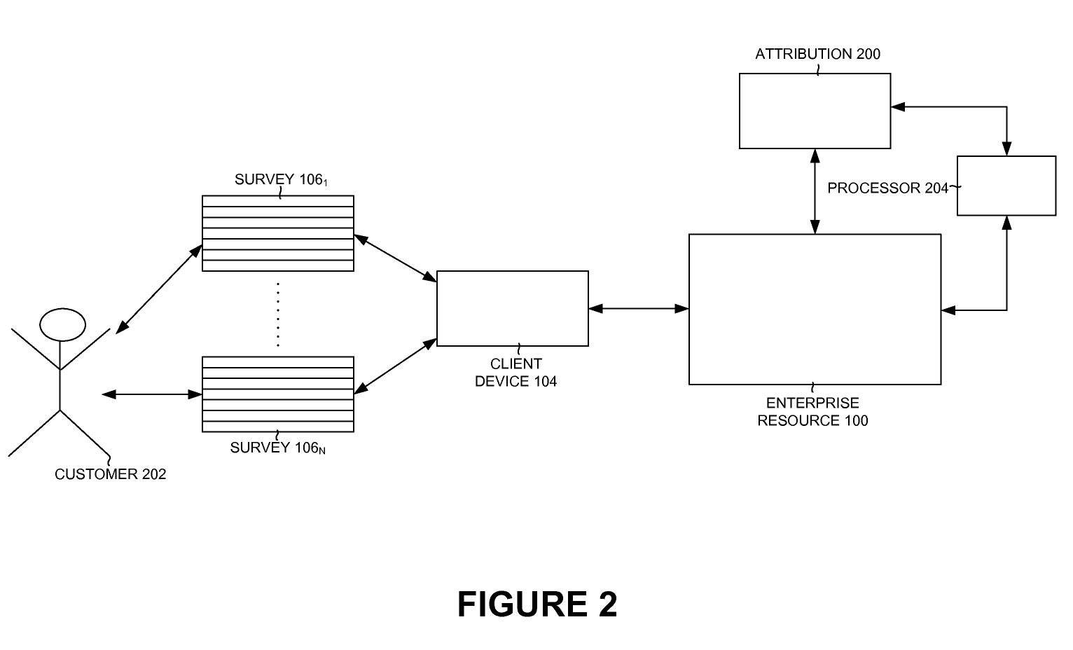

FIG. 2 illustrates a system of quantitative marketing research where user responds to surveys providing information, according to one or more embodiments. In one or more embodiments, the system may provide an Enterprise Feedback Management (EFM). The EFM may be a system of processes and software that enables organizations to centrally manage deployment of the surveys 106_{1-N} while dispersing authoring and analysis throughout an organization. The EFM systems may provide different roles and permission levels for different types of users (e.g., customers) including, but not limited to novice survey authors, professional survey authors, survey reporters and translators. The EFM can help an organization establish a dialogue with employees, partners, and customers regarding key issues and concerns and potentially make customer specific real time interventions. EFM consists of data collection, analysis and/or reporting.

Survey software may be deployed in departments lacking user roles, permissions and workflow. The EFM may enable deployment across an enterprise, providing decision makers with important data for increasing customer satisfaction, loyalty and lifetime value. The EFM may enable companies to look at the customer(s) 202 “holistically” and to better respond to the customer(s) 202 needs. In one or more embodiments, the EFM applications may support complex survey design, with features such as question and page rotation, quota management and advanced skip patterns and branching. The survey software may also offer advanced reporting with statistical analysis and centralized panel management. The EFM applications may be integrated with external platforms, for example Customer Relationship Management (CRM) systems but also with Human Resource Information systems (HRIS) and/or generic web portals.

In addition, the EFM applications may provide a workflow process with user roles and permissions, so that users may be able to author a survey but require another user to approve it before the survey is published. Such workflow ensures consistent survey quality and enforces respondent privacy and Information Technology (IT) security policies. Applications of the EFM vary widely from Human Resource (HR), IT, marketing, sales and may continue to expand on its corporate implementation and scope. Departments within an organization may collaborate on feedback initiatives, sharing results and gaining insights that enable the organization to listen, learn and react to the needs of their key stakeholders. A key part of the value of an EFM deployment is the development of the business rules (i.e., who needs to see what feedback info) and which parts of the customer/employee/partner facing process needs to be measured.

Data can be collected across different surveys 106_{1-N} from the client device(s) 104_{1-N}. The data can be collected from the perspective of the enterprise or company selling the product. The collected data may be compiled using a processor 204 and used to assess customer loyalty and the customer experience. In one or more embodiments, the data and the compiled information may be stored in the enterprise resource 100. Based on the compiled information, the process of attribution 200 may be performed and attributes may be generated using the processor 204. The generated attributes may be stored in a database maintained by the enterprise.

An Enterprise Resource Platform (ERP) may be used to analyze the collected data. The collected data may include, but is not limited to, behavioral data, attitudinal data, a biographical data, a historical data, a geographical data, a general data, a specific data, a collective data, an opinion data, an attitudinal data and a behavioral data. The behavioral data may include information that may relate to the actions of a customer such as purchasing a product.

The attitudinal data may include information that relates to the thoughts of the customer such as the likelihood that the customer would purchase the product again or recommend the product to a friend, colleague, or family member. The attitudinal data may not be readily available to an enterprise. The collection of attitudinal data, the analysis of the data, and a report of the data can provide valuable information to a company seeking to increase its understanding of its customers. Such understanding can assist in the future growth of the company.

Understanding the attitudinal data may be helpful in making business decisions that affect the future growth of the company. The customer(s) 202 may be happy or unhappy with the company or its products. In addition, the customer(s) 202 may promote or detract a company or its products.

In one or more embodiments, the data can be a used as a tool in improving customer loyalty. Improvements in the customer loyalty may result in references from the customers 202 which can yield increased revenues.

The behavioral data may be used in conjunction with the attitudinal data. The mapping of behavioral data with attitudinal data may provide useful information about customer preferences. The attitudinal data may be collected across different surveys 1061-N. For example, different departments of the same company may survey customers. In one or more embodiments, the marketing department, the sales department, and/or the support department may each send a survey.

Analyzing the data across all three surveys can be helpful. A particular person may have responded to two or three of the surveys. Those surveys may have the same questions. The response by the particular person to the same question in the different survey can provide useful customer loyalty information. The survey 1061-N may ask different questions but try to illicit the same information. For example, the survey for the marketing department of Company X may ask “How likely are you to recommend Company X?” The survey for the sales department of Company X may ask “Would you to recommend Company X?” The support department of Company X may ask “Are you satisfied with Company X?” In this example, the survey seeks to gather is the likelihood the customer would recommend the company to someone else.

The data can be analyzed as three different questions with three different answers. Alternatively, the data can be analyzed as one question asked in three different ways and the responses can be converted a single recommend score. By treating the three questions as essentially one question, the data can be simplified and consolidated. The responses can be averaged to yield a single recommend score. Variations of the same question may include variations in grammar, language style, and language.

A recommend score may be likelihood the customer 202 recommends the object of the score. For example, a recommend score of a company may be the likelihood a customer recommends the company. A recommend score of a product may be the likelihood a customer recommends the product.

The attitudinal data, such as the recommend score may be mapped with the behavioral data, such as transactional data. For example, a particular customer may purchase an item. That purchase may be recorded as an entry in the behavioral data set. In addition, that same customer may complete three different surveys from three different departments of the same company yielding a single recommend score for that person about that company. The purchase of the product coupled with the recommend score can provide information about the customer loyalty that particular customer has toward the company.

Recommend scores can link a particular company to a company or a product of the company. For example, Customer Y may have one recommend score for Company X and a different recommend score for Product Z, which is manufactured by Company X.

Labels for the recommend score can be created. For example, PersonY.CompanyX.RecommendScore may be a label for the recommend score for Company X. PersonY.CompanyX.ProductZ.RecommendScore may be a label for a recommend score for Product Z, which is manufactured by Company X.

A longitudinal study may be a correlation research study that involves repeated observations of same items over long periods of time (e.g., sometimes even for many decades). It is a type of observational study. Unlike cross-sectional studies, longitudinal studies may track the same people, and therefore the differences observed in those people are less likely to be the result of cultural differences across generations. Because of this benefit, longitudinal studies make observing changes more accurate and they are applied in various other fields.

Types of longitudinal studies may include cohort studies and panel studies. Cohort studies sample a cohort, defined as a group experiencing some event in a selected time period, and studying them at intervals through time. Panel studies sample a cross-section, and survey it at (usually regular) intervals.

Participants of a survey may be identified. Once the participant is identified, that participant can be compared to all of the other participants in the database. If the participant is already in the database, then additional data can be collected on the participant. For example, Customer Y may have one recommend score for Company X at a given time and a different recommend score for Company X at a different time. The changes in recommend score can be tracked over time. Such tracking can provide customer loyalty information.

If the participant in not in the database a new entry can be added for that participant and a unique registration record for the participant may be generated. If there are errors with respect to the recording of longitudinal data, the errors can be corrected.

The survey systems have model that define questions using which data is collected form survey participants. This means that the same question when asked in different surveys could be codified differently in different surveys with labels and aliases in the system and in the database making it difficult for one to understand and report responses to the same question from across surveys. The individuals may be surveyed in a manner by which participants are identified by their name or email address and both individual survey definition and its participants lives in isolated systems making it difficult to identify and learn history of their responses across all surveys they have taken and across timeline.

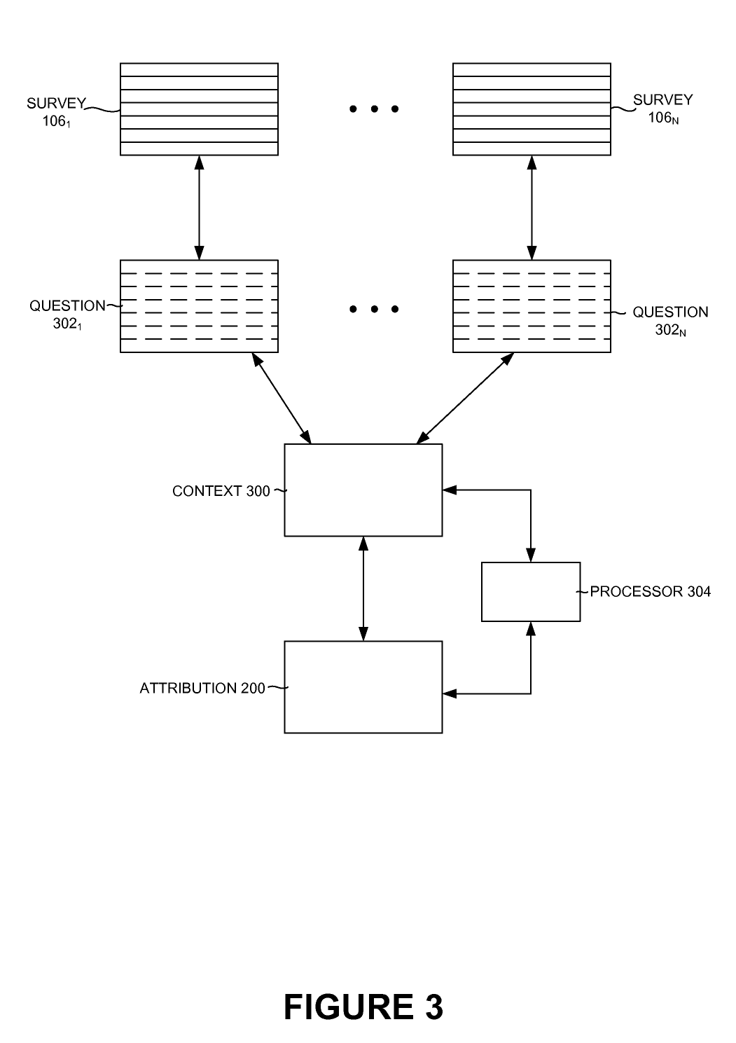

FIG. 3 illustrates a process of attribution 200 from the surveys 106_{1-N}, according to one or more embodiments. Models and methods can allow users to understand questions within or across all surveys 106_{1-N} irrespective of its how it was asked, labeled or aliased, by decoupling the context and the attribution 200 of the data it captures along with hierarchy and relationship between the various data captured though surveys. This help unlock the data captured through different surveys providing a unifying model for machines to analyze, report and act on participant responses or patterns/trend detected in the data within or across surveys for one more multiple participants or participant demographics.

In one or more embodiments, the system may generate questions 3021-N using a processor 304 based on context 300. The questions 3021-N may be put provided to users via the survey(s) 1061-N. The responses may be analyzed and modified in the context and the attributes are generated using the processor 304 through the attribution 200 process.

For example, survey participants may be provided with a following question: “How satisfied are you with Printer N234 from generic Corp?”

The response captured to this question to a file f1 may be less meaningful because the context of the response is lost. If the mode support contexts and attributions 200 then the data becomes rich with metadata that may allow the machine (e.g., server, computer) to understand the attribution 200, relationship and context of that piece of data provided by the participant. In the above example, the attribution 200 of the data may be defined as Company.Prouct.Satisfaction_Score that defines it as capturing the participant's response to the attribute Satisfaction_Score of Product of a Company where Company is “generic Corp” and Product is “Printer N234” and that would make it semantically useful for machine to process ([Company=generic Corp][Product=Printer N234][Satisfaction=7]). Using this model one can apply aggregation or logic on data to find correlation, mathematical or statistical functions, etc. (e.g. average satisfaction_score across all products of a company, or average satisfaction score of products across all companies, or to correlate satisfaction score of product1 vs. product2 by different demographics of participants. This method can be used to provide rich and intelligent insight into customer's attitudinal data across multiple dimension and periods to solve various business problems. This will also provide rich capabilities to benchmark data across multiple dimension, at various aggregation levels and slices and dices of interest.

In addition to the above technique, another technique allows one to identify and track a person's response over time, across surveys and across companies. People are sampled for participation. Information captured about the participant may be a snapshot of information at that point in time. When the same person is surveyed over time in different surveys or by different companies, the personal information of the participant may change in those surveys leaving the machine without information to identify all the responses of the same person. Another technique creates a unique registration record for each participant and identifies their unique registration using fuzzy logic to match a participant on multiple identification attributes allowing the system to tag each participant to their unique registration record in the system. This allows the system to drill down from the registration record to all unique participation records of the person across time, surveys and companies giving the system a compressive view of the person's attitudinal data over multiple dimensions, at various aggregation levels and slices and dices of interest.

In addition to the above, these methods have wide unique and novel applicability within enterprise information system. In one or more embodiments, the attitudinal data rich of its contexts that may include reference data such as contact or personal information of the participant may be used to automatically update and maintain enterprise information systems to keep information up to date. This may allow customer to self update and maintain information in the enterprise information repository though regular surveys sent to them with any additional process control that may be included for review and approval if desired. In one or more embodiments, an xpath mapping may be used to map the data attributes captured through surveys to the enterprise data model attributes that it represents.

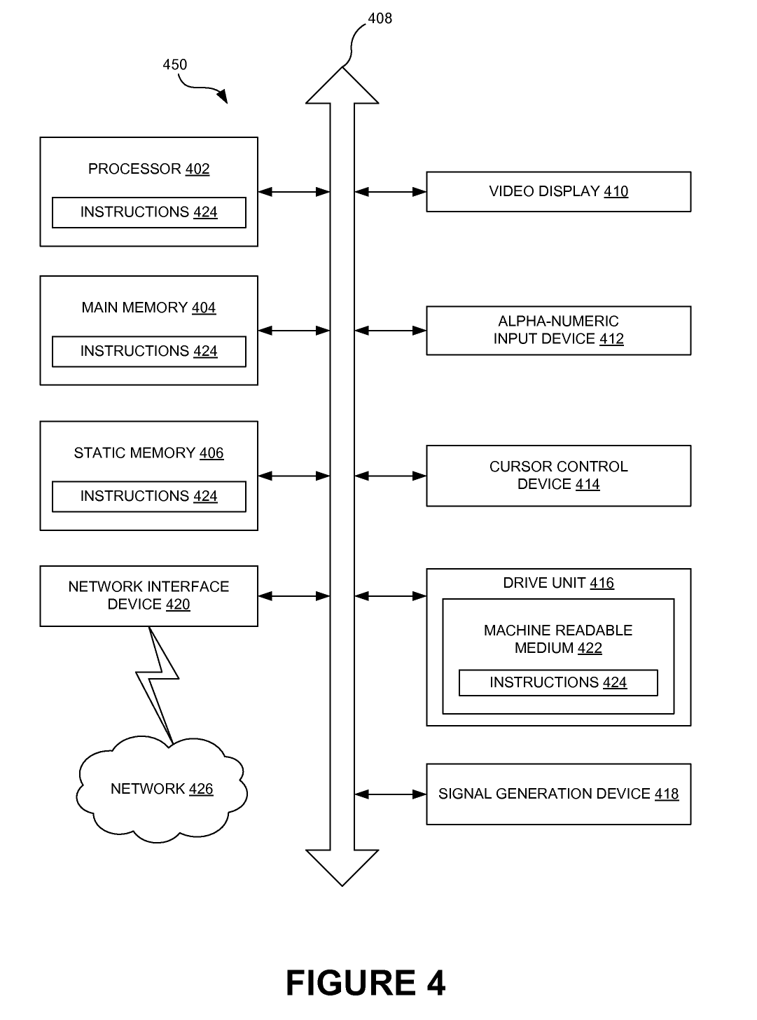

FIG. 4 is a diagrammatic system view 400 of a data processing system in which any of the embodiments disclosed herein may be performed, according to one embodiment. Particularly, the diagrammatic system view 400 of FIG. 4 illustrates a processor 402, a main memory 404, a static memory 406, a bus 408, a video display 410, an alpha-numeric input device 412, a cursor control device 414, a drive unit 416, a signal generation device 418, a network interface device 420, a machine readable medium 422, instructions 424, and a network 426, according to one embodiment.

The diagrammatic system view 400 may indicate a personal computer, the data processing system, the enterprise resource 100, and/or one or more client devices 104_{1-N} in which one or more operations disclosed herein are performed. The processor 402 may be a microprocessor, a state machine, an application specific integrated circuit, a field programmable gate array, etc. The main memory 404 may be a dynamic random access memory and/or a primary memory of a computer system.

The static memory 406 may be a hard drive, a flash drive, and/or other memory information associated with the data processing system. The bus 408 may be an interconnection between various circuits and/or structures of the data processing system. The video display 410 may provide graphical representation of information on the data processing system. The alpha-numeric input device 412 may be a keypad, a keyboard and/or any other input device of text (e.g., a special device to aid the physically handicapped).

The cursor control device 414 may be a pointing device such as a mouse. The drive unit 416 may be the hard drive, a storage system, and/or other longer term storage subsystem. The signal generation device 418 may be a bios and/or a functional operating system of the data processing system. The network interface device 420 may be a device that performs interface functions such as code conversion, protocol conversion and/or buffering required for communication to and from the network 426. The machine readable medium 422 may provide instructions 424 on which any of the methods disclosed herein may be performed. The instructions 424 may provide source code and/or data code to the processor 402 to enable any one or more operations disclosed herein.

Although the present embodiments have been described with reference to specific example embodiments, it will be evident that various modifications and changes may be made to these embodiments without departing from the broader spirit and scope of the various embodiments.

What is claimed is:

1. A method comprising:
conducting a survey on a set of participants;
obtaining a set of data from a set of participants through a network coupled to a data processing system;
compiling the set of data in an enterprise resource based on the set of data obtained from the set of participants;
analyzing the set of data in the enterprise resource; and
creating a marketing plan.

2. The method of claim 1 further comprising:
defining a problem;
researching a design specification to solve the problem;
conducting the survey based on the design specification;
collecting the set of data obtained from the survey;
refining the set of data to produce a result; and
writing and presenting a research report based on the result.

3. The method of claim 2 further comprising:
identifying a set of information associated with the problem;
conceptualizing the set of information associated with the problem;
defining a set of concepts associated with the problem;
translating the set of concepts into a set of observable and measurably behaviors; and
creating the survey based on the set of concepts associated with the problem.

4. The method of claim 3 further comprising:
researching the design specification to create a methodology for the survey,
wherein the methodology is at least one of a questionnaire, a poll, and a scale;
generating a set of questions based on the methodology;
determining an order of the questions based on the methodology;
scaling the design specification to include a definition of preferences that are to be rated; and
sampling the design specification to determine a set of properties associated with the design specification.

5. The method of claim 4 wherein the set of properties associated with the design specification is at least one of a total population size, a sample size necessary for the total population size and a sampling method.

6. The method of claim 5 wherein the sampling method is at least one of a probability sampling, a cluster sampling, a stratified sampling, a simple random sampling, a multistage sampling, a systematic sampling, a non-probability sampling, a convenience sampling, a judgment sampling, a purposive sampling, a quota sampling and a snowball sampling.

7. The method of claim 6 wherein the set of data is collected through at least one of a mail collection, a telephone collection, an internet collection, a public place collection, an oral survey collection, a door-to-door collection and a mall intercepts collection.

8. The method of claim 7 further comprising:
performing a set of adjustments to the set of data such that the data is compatible with a group of statistical techniques,
wherein the set of adjustments is at least one of a codification of the data, a re-specification of the data, an assigning of numbers to the data, a performing of consistency checks on the data, a substituting of the data, a deleting of the data, a weighing of the data, an assigning of dummy variables to the data, a transformations of a scale of the data and a standardizing of the scale of the data;
producing the result based on the set of adjustments; and
performing a set of statistical analysis on the result,
wherein the set of statistical analysis is at least one of a performing a descriptive statistical analysis, an inferential statistical analysis, a making of an inference from the sample to the whole population and a testing of the result for statistical significance.

9. The method of claim 8 further comprising:
analyzing the result,
wherein the result is analyzed through at least one of an interpretation of the result, a drawing of a conclusion and a relating of the result to a similar research.

10. The method of claim 9 further comprising:
preparing the research report based on the result,
wherein the research input includes at least one of an executive summary, an objective, a methodology, a main finding, a detailed chart and a diagram.

11. The method of claim 1 further comprising:
responding to the survey through a client device;
communicating a response of the participant over the network; and
aggregating the response and a set of responses in an aggregate survey.

12. The method of claim 1 further comprising:
providing an Enterprise Feedback Management (EFM) system to centrally manage a deployment of the survey,
wherein the EFM system is at least of a system of processes and a software; and
dispersing an authoring and an analysis of the survey throughout an organization through the EFM system.

13. The method of claim 12 further comprising:
providing, through the EFM system, a set of different roles to a set of users in the organization based on a permission level of the user, wherein the set of different roles is at least one of a novice survey author, a professional survey author, a survey reporter and a translator;
providing a set of options associated with survey design through the EFM system,
wherein the set of options associated with survey design pertains to features such as at least one of a question, a page rotation, a quota management, an advanced skip pattern and a branching; and
providing an advanced reporting feature through the EFM system,
wherein the advanced reporting feature offers at least one of an advanced statistical analysis feature and a centralized panel management feature.

14. The method of claim 13 further comprising:
providing a workflow process enabling the set of users of the organization to work on a set of multiple surveys efficiently; and
permitting a second user of the organization to approve a survey authored by a first user of the organization.

15. The method of claim 1 further comprising:
generating a set of attributes based on the set of data through a processor; and
storing the set of attributes in a database.

16. The method of claim 15 further comprising:
analyzing the set of data through an Enterprise Resource Platform (ERP), wherein the set of data is at least one of a biographical data, a historical data, a geographical data, a general data, a specific data, a collective data, an opinion data, an attitudinal data and a behavioral data.

17. The method of claim 16 further comprising:
identifying the participant of the survey;
tracking a response of the participant;
creating a unique registration record for the participant;
generating a compressive data associated with a unique data of the participant;
analyzing the compressive data associated with the unique data of the participant to look for trends;
focusing on a portion of the compressive data associated with the unique data of the participant based on a preference of the user;
comparing the participant of the survey with a set of all participants in the database;
decoupling a context and an attribution process associated with the set of data;
capturing a hierarchy and a relationship between the set of data captured through a set of multiple surveys;
combining the set of data captured through the set of multiple surveys; and
analyzing and reporting based on the set of data captured through the set of multiple surveys.

18. The method of claim 17 further comprising:
permitting the participant to update and maintain the set of data in the enterprise resource.

19. A method comprising:
creating a survey to solve a problem;
sending a survey to a participant through a network;
collecting a set of data associated with the survey based on a response of the participant;
compiling the set of data in an enterprise resource;
generating a set of attributes based on the set of data through a processor; and
decoupling a context and an attribution process associated with the set of data to filter and categorize the set of data; and
analyzing the set of data.

20. A system comprising:
an enterprise resource to store a set of data collected from a set of participants;
a survey to find a solution to a problem;
a network to communicate the survey from the set of participants to the enterprise resource;
an attribution process to generate a set of attributes of the set of data;
a processor to generate the set of attributes and to decouple a context of the data and a set of attributes of the set of data; and
a data processing system to collect, analyze and organize the set of data obtained, wherein the data processing system further comprises of at least one of a processor, a main memory, a static memory, a bus, a video display, an alpha-numeric input device, a cursor control device, a drive unit, a signal generation device, a network interface device, a machine readable medium, and a set of instructions.
